(19) United States
(12) Patent Application Publication
(10) Pub. No.: US 2014/0104883 A1
(43) Pub. Date: Apr. 17, 2014

(54) IMAGE DISPLAY APPARATUS AND ELECTRONIC APPARATUS

(71) Applicant: Kabushiki Kaisha Toshiba, Tokyo (JP)

(72) Inventor: Takashi Asano, Fukaya-shi (JP)

(73) Assignee: KABUSHIKI KAISHA TOSHIBA, Tokyo (JP)

(21) Appl. No.: 14/011,540

(22) Filed: Aug. 27, 2013

Related U.S. Application Data
(63) Continuation of application No. PCT/JP2013/068460, filed on Jun. 28, 2013.

(30) Foreign Application Priority Data
Oct. 12, 2012 (JP) 2012-227169

(51) Int. Cl. F21V 8/00

(52) U.S. Cl. CPC G02B 6/0085
USPC 362/615

(57) ABSTRACT

An electronic apparatus according to an embodiment includes a case, a display panel, a back light, a middle support, a heat diffuser, and a shield. The back light includes a light guiding plate and a plurality of light emitting elements. The middle support behined the back light includes a connecting window on a side close to the light emitting elements. The heat diffuser is thermally connected to the light emitting elements, crosses over the connecting window, and extends toward a center area between the light guiding plate and the middle support. The shield is disposed at a back of the middle support, and is thermally connected to the heat diffuser through the connecting window.

### CROSS REFERENCE TO RELATED APPLICATIONS

This application is a Continuation Application of PCT Application No. PCT/JP2013/068460, filed Jun. 28, 2013 and based upon and claiming the benefit of priority from Japanese Patent Application No. 2012-227169, filed Oct. 12, 2012, the entire contents of all of which are incorporated herein by reference.

### FIELD

Embodiments described herein relate generally to an image display apparatus and an electronic apparatus.

### BACKGROUND

A television is provided with a back light and a liquid crystal panel. The back light includes an LED (Light Emitting Diode) that is to be a source of light at one edge on an outer circumference of a light guiding plate. In order to diffuse heat that the LED generates, a heat diffusing plate formed of aluminum alloy and covering an entirety of a back surface of the light guiding plate is disposed.

As a display section of the television and the electronic apparatus becomes large, the back light becomes large. Further, since sufficient brightness as a back light is necessary, an output of the LED becomes large, which results in a larger heat quantity. In the case of disposing the heat diffusing plate so as to cover the entirety of the back surface of the light guiding plate to diffuse the heat of the LED, it seems as though the heat is efficiently diffused. However, the heat diffusing plate is thin, and the LED is disposed along one edge on the outer circumference of the heat diffusing plate, so a thermal gradient with a side on which the LED is disposed as a high temperature side is generated. That is, when the liquid crystal panel and the back light become large to a certain extent, an inclination occurs in a temperature distribution. Further, even if the heat diffusing plate is formed of aluminum alloy, it becomes a cause of a weight increase with the television becoming large-sized, and a material cost becomes higher.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view of a television of an embodiment;

FIG. 2 is a back side view of a middle support of the television of FIG. 1;

FIG. 3 is a cross sectional view of the television along an F3-F3 line in FIG. 2;

FIG. 4 is a cross sectional view enlarging an F4 portion of FIG. 3; and

FIG. 5 is a cross sectional view enlarging an F5 portion of FIG. 3.

### DETAILED DESCRIPTION

Various embodiments will be described hereinafter with reference to the accompanying drawings.

An electronic apparatus according to an embodiment includes a case, a display panel, a back light, a middle support, a heat diffuser, and a shield. The case has an opening at one surface. The display panel exposes its display surface from the opening. The back light includes a light guiding plate and a plurality of light emitting elements. The light guiding plate is disposed at a back of the display panel. The light emitting elements are arranged along an edge of the light guiding plate. The middle support behined the back light includes a connecting window on a side close to the light emitting elements. The heat diffuser is thermally connected to the light emitting elements, crosses over the connecting window, and extends for a predetermined width toward a center area between the light guiding plate and the middle support. The shield is disposed at a back of the middle support, and is thermally connected to the heat diffuser through the connecting window.

An embodiment provides an image display apparatus and an electronic apparatus that discharge heat that a light source generates, at low cost and with high efficiently.

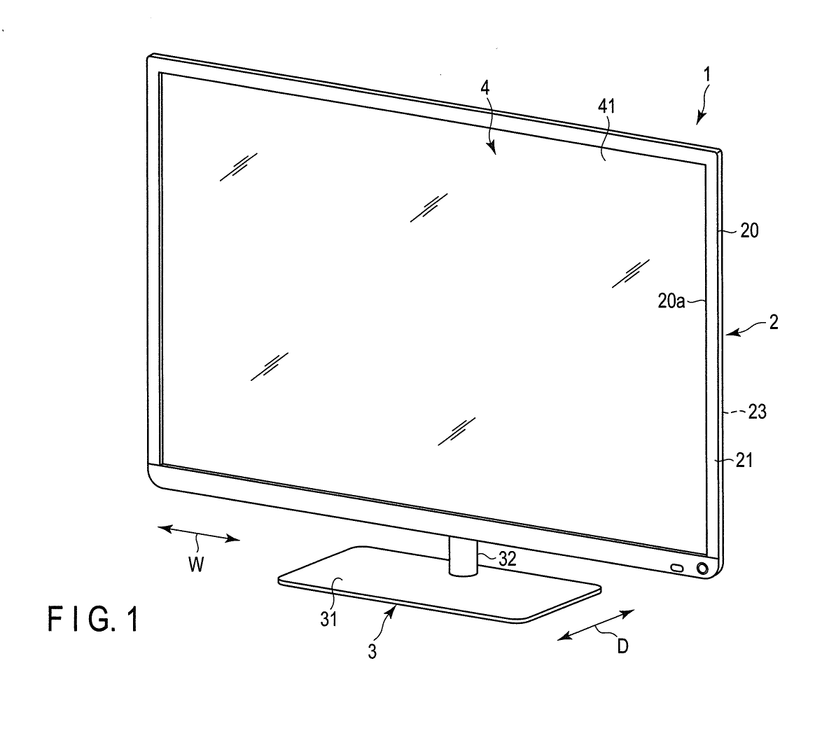

The electronic apparatus or the image display apparatus of the embodiment will be described with reference to FIG. 1 to FIG. 5 by taking a television 1 as an example. The television 1 shown in FIG. 1 includes a main body 2 and a stand 3. The main body 2 houses a display panel 4, a back light 5, a middle support 24, a heat diffuser 6, a shield 7, and circuit boards 8 in a case 20 that forms an outer shell.

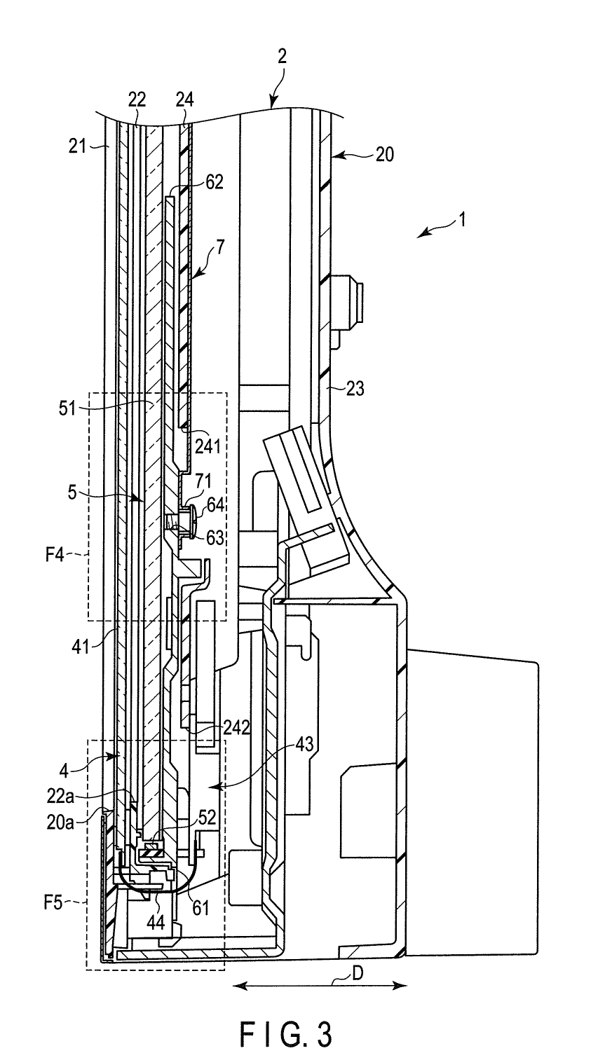

The case 20 has an opening 20a at one surface. In the description, a side on which the opening 20a is provided will be termed “fore” or “front”, and an opposite side of the front surface will be termed “back”, “behind” or “rear”. Further, “right” and “left” will be defined with the front surface as the reference as seem from a user, and a direction along the front surface will be termed a widthwise direction W, and a direction perpendicular to the front surface will be termed a depth direction D. As shown in FIG. 1, the case 20 has a square box shape that is flat in the direction perpendicular to the opening 20a, that is, in the depth direction D, and as shown in FIG. 3, the case 20 includes a front frame 21, a middle frame 22, a rear frame 23, and the middle support 24. The opening 20a is formed in the front frame 21.

As shown in FIG. 1, the stand 3 includes a pedestal 31 and a stem 32. The pedestal 31 has a size that is sufficient for the television 1 to stand on its own. The stem 32 is attached to a lower portion of the back surface of the main body 2, and retains the main body 2 in an upright posture. The main body 2 may rotate with the stem 32 as a center so that the front surface can face rightward or leftward.

The display panel 4 is assembled into the case 20 in a state in which a display surface 41 is exposed from the opening 20a. The display panel 4 is for example a liquid crystal cell, and as shown in FIG. 3, its outer circumferential portion 42 is inserted between the front frame 21 and the middle frame 22. The middle frame 22 has a light permeating window 22a that has a substantially same size as the opening 20a of the front frame 21.

The back light 5 is positioned behind the display panel 4, which is at the back of the middle frame 22 in the embodiment. The back light 5 includes a light guiding plate 51, and a plurality of light emitting elements 52 that is to be a light source. The light guiding plate 51 includes a prism sheet 511 and a light diffusing sheet 512 at the front and a light reflecting sheet 513 at the back, respectively. The light emitting elements 52 are light emitting diodes (LEDs), and are disposed aligning along one edge of the light guiding plate 51, which is a lower rim 511 in the embodiment. Each of the light emitting elements 52 is mounted on the board 53. Light emitted from the light emitting elements 52 enters from the lower rim 511 of the light guiding plate 51 to between the front surface and the back surface, is repeatedly reflected within the light guiding plate 51, and thereafter is ejected from the front surface.

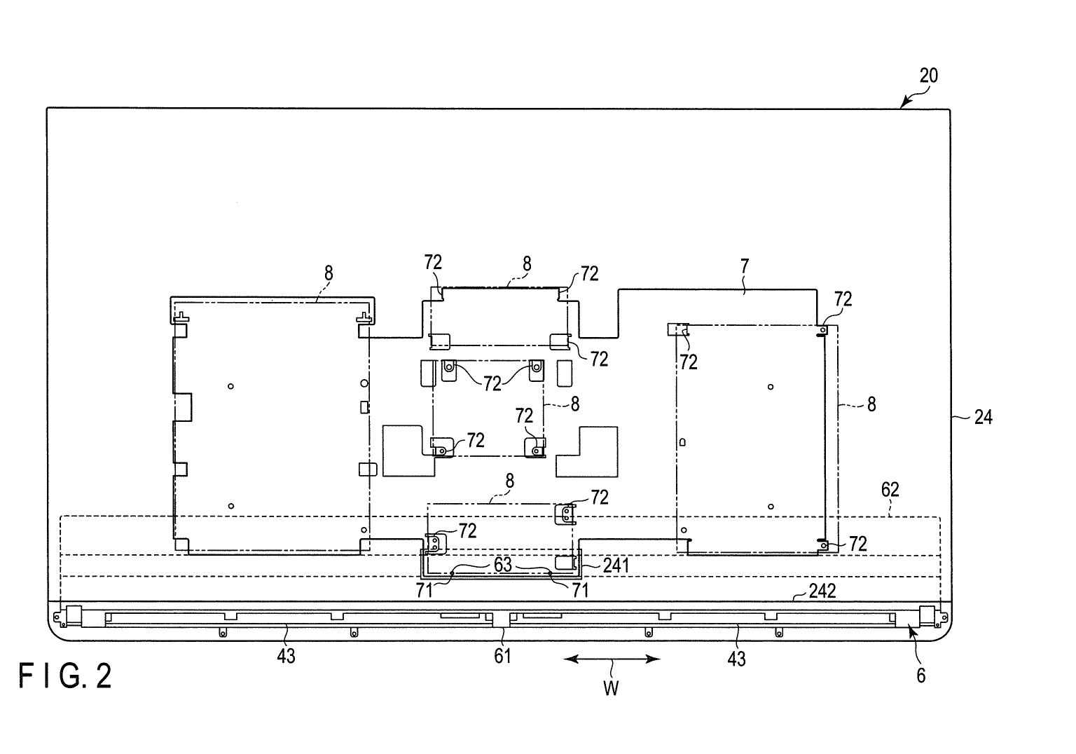

The middle support 24 is disposed between the middle frame 22 and the rear frame 23 these are on the back side of the back light 5 as shown in FIG. 3, and includes a connecting window 241 at a center portion near a lower portion that is close to the light emitting elements 52 as shown in FIG. 2.

The heat diffuser 6 extends over the connecting window 241 toward the center area between the light guiding plate 51 and the middle support 24. A lower end portion 61 of the heat diffuser 6 extends toward the front underneath the lower rim 511 of the light guiding plate 51, and is thermally connected to the light emitting elements 52 via the board 53 onto which the light emitting elements 52 are mounted. An upper end 62 of the heat diffuser 6 is lower than half the display panel 4, at a position of about one-fourth of the display panel 4. The heat diffuser 6 has a heat capacity and heat discharging area that are sufficient enough so as not to generate warpage at a periphery thereof by heat generated by the light emitting elements 52 being transmitted thereto.

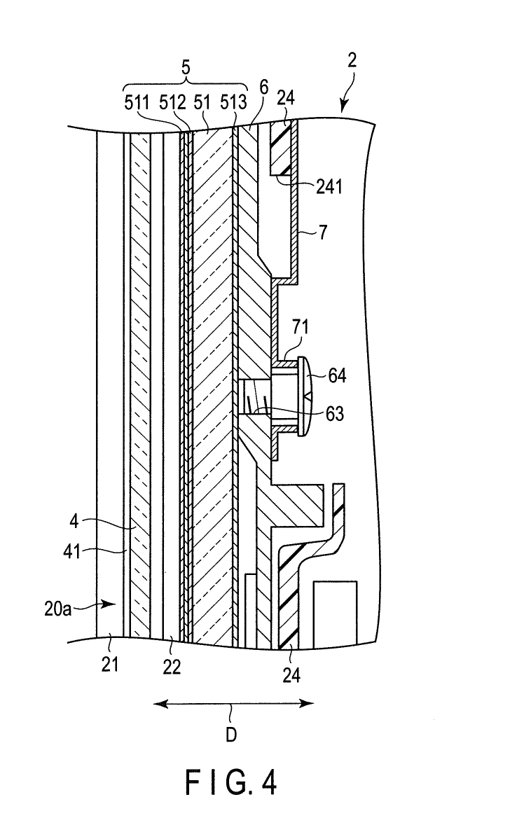

The shield 7 is disposed behined the middle support 24 as shown in FIG. 2, and is thermally connected to the heat diffuser 6 through the connecting window 241 shown in FIG. 3 and FIG. 4. The shield 7 makes surface contact with the heat diffuser 6 in a range on an inner side than the connecting window 241. The shield 7 is formed by pressing a conductive thin plate, and includes a collar 71 at a portion positioned on the inner side of the connecting window 241 as shown in FIG. 4. The collar 71 extends toward a direction apart from the heat diffuser 6 at a size that is substantially same as a thickness of the middle support 24. The heat diffuser 6 includes threaded holes 63 at positions corresponding to the collar 71. The shield 7 and the heat diffuser 6 are fastend by screws 64 inserted through the shield 7. The shield 7, as shown in FIG. 2, has a larger surface area than the heat diffuser 6.

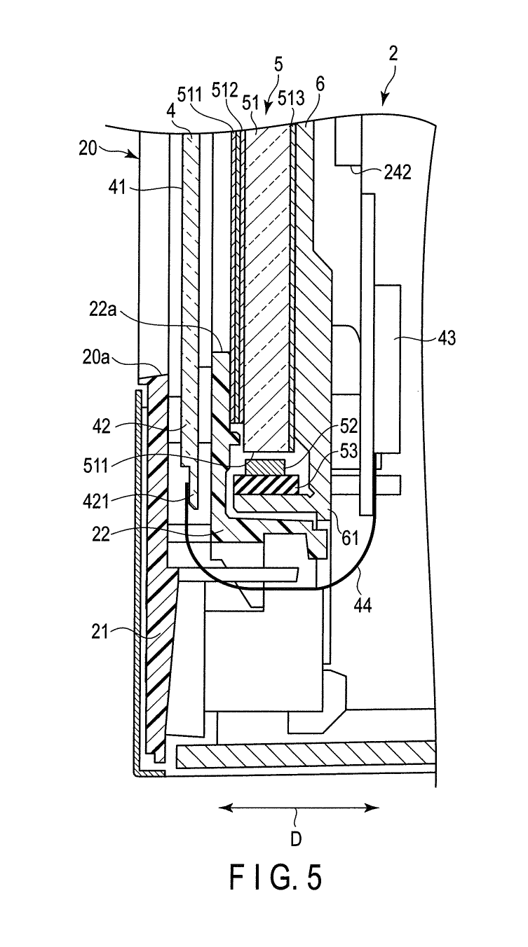

The back light 5 and the heat diffuser 6 extend downward beyond a lower rim 242 of the middle support 24. The display panel 4 has a drive source board 43, which causes the crystal cell to operate, disposed behind the heat diffuser 6 that extends downward beyond the lower rim 242 of the middle support 24. As shown in FIG. 3 and FIG. 5, the drive source board 43 is connected to a lower rim 421 of the display panel 4 via a flexible printed wiring board 44 disposed to go around the lower rim of the back light 5 where the light emitting elements 52 are disposed.

Further, the circuit boards 8 include a main board, a power circuit board and the like, and are disposed on the rear side of the shield 7 as shown in FIG. 2. The shield 7 includes leg portions 72 that stand up backward. Each circuit board 8 is supported by the leg portions 72.

The television 1 as configured above diffuses and discharges the heat that the light emitting elements 52 that are the light source generates by the heat diffuser 6 disposed in a range on a lower portion side of the case 20, and further transmits the heat to the shield 7. By a size of the heat diffuser 6 from a lower end to an upper end where the light emitting elements 52 that are the heat source are disposed being small, the heat is evenly transmitted to an entirety of the heat diffuser 6, and distortion or warpage of the heat diffuser itself can be prevented.

Further, since the heat diffuser 6 is connected to the middle support 24 and is not connected to the light guiding plate 51 and the display panel 4, no direct influence will be imposed even if the heat diffuser 6 expands by the heat. Further, the shield 7 is connected to the heat diffuser 6 at an inner side of the connecting window 241 of the middle support 24. This connecting window 241 is positioned at a center of a lower portion of the middle support 24. Hence, distortion and warpage is unlikely to occur since the connected portion is only at the portion of the connecting window 241, even if there is a temperature difference between the heat diffuser 6 and the shield 7.

Accordingly, the television 1 has a low cost due to the heat diffuser 6 being partially provided, and heat discharging can efficiently be performed by also using the shield 7 due to the heat diffuser 6 and the shield 7 being connected through the connecting window 241.

In the embodiment, the television 1 was described as an example of the electronic apparatus or the image display apparatus. The electronic apparatus and the image display apparatus, other than a television, include those provided with light emitting element (for example, an LED) that generates heat as a light source of the back light 5 and include a heat diffuser for efficiently diffusing the heat of the light emitting element, such as a monitor for a computer, and a display portion of a slate type computer or a laptop computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a case comprising an opening in one surface;
a display panel exposing a display surface through the opening;
a backlight comprising a light guiding plate behined the display panel, and a plurality of light emitting elements arranged along an edge of the light guiding plate;
a middle support behined the backlight comprising a connecting window on a side close to the light emitting elements;
a heat diffuser thermally connected to the light emitting elements, crossing over the connecting window, and extending for a predetermined width toward a center area between the light guiding plate and the middle support; and
a shield on a back of the middle support thermally connected to the heat diffuser through the connecting window.

2. The electronic apparatus of claim 1, wherein
the shield makes a surface contact at an inner side of the connecting window.

3. The electronic apparatus of claim 1, further comprising:
a drive source board behind the heat diffuser connected to the display panel via a flexible printed wiring board disposed to go around a rim of the backlight where the light emitting elements are disposed.

4. The electronic apparatus of claim 1, wherein
the shield comprises a collar that extends in a direction apart from the heat diffuser,
the heat diffuser comprises a threaded hole at a position corresponding to the collar portion, and
the shield and the heat diffuser are fastend by a screw inserted through the shield.

5. The electronic apparatus of claim 1, wherein
the shield has a larger surface area than the surface area of the heat diffuser.

6. The electronic apparatus of claim 1, wherein
the connecting window is positioned close to a center of a lower portion of the middle support.

7. The electronic apparatus of claim 1, wherein
the heat diffuser extends downward beyond a lower rim of the middle support.

8. The electronic apparatus of claim 1, further comprising:
at least one circuit board behind the shield,
the electronic apparatus wherein the shield includes a leg portion that is stand backward to support the circuit board.

9. A display apparatus comprising:
a case comprising an opening on one surface;
a display panel exposing a display surface from the opening;
a backlight comprising a light guiding plate behind the display panel, and a plurality of light emitting elements arranged along an edge of the light guiding plate;
a middle support that supports the display panel and the backlight from a rear side, and comprising a connecting window on a side close to the light emitting elements;
a heat diffuser thermally connected to the light emitting elements, crossing over the connecting window, and extending for a predetermined width toward a center area between the light guiding plate and the middle support;
a shield disposed on a back of the middle support, and thermally connected to the heat diffuser through the connecting window; and
at least one circuit board behind the shield.
